(19) United States
(12) Patent Application Publication
(10) Pub. No.: US 2012/0288046 A1
(43) Pub. Date: Nov. 15, 2012

(54) Signal Calibration Method and Client Circuit and Transmission System Using the Same

(76) Inventors: Hsueh-Yi Lee, Hsinchu County (TW); Chih-Wei Tang, Penghu County (TW); Kuan-Hua Chen, Taoyuan County (TW); Wing-Kai Tang, Hsinchu City (TW)

(21) Appl. No.: 13/469,081

(22) Filed: May 10, 2012

(30) Foreign Application Priority Data
May 12, 2011 (TW) 100116733

(51) Int. Cl. H04L 7/04

(52) U.S. Cl. 375/362

(57) ABSTRACT

A signal calibration method for synchronizing a clock signal and at least one data signal in a transmission system is disclosed. The signal calibration method comprises detecting at least one transmission time difference between the clock signal and the at least one data signal transmitted in the transmission system, calculating a plurality of delay periods of the clock signal and the at least one data signal according to the at least one transmission time difference, and respectively delaying the clock signal and the at least one data signal for the plurality of delay periods to synchronize the clock signal and the at least one data signal.

### BACKGROUND OF THE INVENTION

1. Field of the Invention

The present invention relates to a signal calibration method and a client circuit and a transmission system, and more particularly, to a signal calibration method and the client circuit and the transmission system for determining a transmission time in a client, and synchronizing a clock signal and a data signal accordingly.

2. Description of the Prior Art

As the advancement of technology, the amount of data transmission in electronic products becomes more. Under this circumstance, high speed serial transmission technology, such as Mobile Industry Processor Interface (MIPI) and Universal serial Bus (USB), has been widely used. However, high speed transmission implies less tolerance of errors.

For example, please refer to FIG. 1, which illustrates a schematic diagram of a high speed serial transmission interface 10 of the prior art. The transmission interface 10 comprises a host circuit 100, transmission lines 110_C, 110_D and a client circuit 120. The host circuit 100 comprises transmitters 102_C, 102_D for transmitting a clock signal CLK and a data signal DA, respectively. The clock signal CLK and the data signal DA are transmitted to the client circuit 120 via the transmission lines 110_C, 110_D. Correspondingly, the client circuit 120 comprises receivers 122_C, 122_D and a processing circuit 124. The receivers 122_C, 122_D receive the clock signal CLK and the data signal DA, respectively. Finally, the processing circuit 124 accesses the data signal DA according to the clock signal CLK. Ideally, as shown in FIG. 2A, transmission time of the clock signal CLK and transmission time of the data signal DA are the same. In FIG. 2A, both rising edges and falling edges of the clock signal CLK are the moments for the processing circuit 124 to access the data signal DA. Besides, shortest periods between the clock signal CLK and the rising edge of the data signal DA as well as the falling edge of the data signal DA are periods Ts and Th. Generally speaking, optimized values of the periods Ts and Th are related to system characteristic, and the design of Ts=Th as shown in FIG. 2A is only one example.

However, in practical application, due to various reasons, such as asymmetrical lengths or loadings of the transmission lines 110_C and 110_D, asymmetrical loadings of receivers 122_C and 122_D, asymmetrical outputs of the transmitters 102_C and 102_D, and discontinuous impedances of the host circuit 100 and the client circuit 120, there is a skew in the transmission interface 10, causing different arrival time of the clock signal CLK and the data signal DA in the client circuit 120. For example, please refer to FIG. 2B and FIG. 2C. FIG. 2B illustrates a signal sequence diagram of the data signal DA leading over the clock signal CLK, and FIG. 2C illustrates a signal sequence diagram of the data signal DA lagging behind the clock signal CLK. In FIG. 2B, the processing circuit 124 accesses data as “0101010” according to the clock signal CLK rather than the correct transmission result “1010101”. Similarly, in FIG. 2C, the processing circuit 124 accesses wrong data as “0101010” according to the clock signal CLK.

Certainly, the transmission interface 10 shown in FIG. 1 is a simplified example. As shown in FIG. 3, more transmission channels can be included in a transmission interface in practical application. In FIG. 3, in a transmission interface 30, there exists leading or lagging relations between the clock signal CLK and the data signals DA1-DAn, such that errors occur when accessing data. In the trend of approaching higher frequency of the clock signal CLK, there is much less error tolerance of skew signals. Therefore, there is a need to improve the transmission interface of the prior art so as to maintain accuracy of data transmission.

### SUMMARY OF THE INVENTION

It is therefore an objective of the claimed invention to provide a signal calibration method and a client circuit and a transmission system using the same.

The present invention discloses a signal calibration method for synchronizing a clock signal and at least one data signal in a transmission system, the signal calibration method comprising detecting at least one transmission time difference between the clock signal and the at least one data signal transmitted in the transmission system; calculating a plurality of delay periods of the clock signal and the at least one data signal according to the at least one transmission time difference; and delaying the clock signal and the at least one data signal for the plurality of delay periods, respectively, to synchronize the clock signal and the at least one data signal.

The present invention further discloses a client circuit for receiving and synchronizing a clock signal and at least one data signal transmitted in a transmission system, the client circuit comprising a plurality of receivers, for receiving the clock signal and the at least one data signal; a calibration circuit, comprising a detecting unit, for detecting at least one transmission time difference between the clock signal and the at least one data signal transmitted in the transmission system; and a calculating unit, for calculating a plurality of delay periods of the clock signal and the at least one data signal according to the at least one transmission time difference; and a plurality of clock delaying units, for delaying the clock signal and the at least one data signal according to the plurality of delay periods, to synchronize the clock signal and the at least one data signal.

The present invention further discloses a transmission system for transmitting a clock signal and at least one data signal, the transmission system comprising a host circuit comprising a plurality of transmitters, for transmitting the clock signal and the at least one data signal; a plurality of transmission lines, for transmitting the clock signal and the at least one data signal, respectively; a client circuit comprising a plurality of receivers, for receiving the clock signal and the at least one data signal; a calibration circuit, comprising a detecting unit, for detecting at least one transmission time difference between the clock signal and the at least one data signal transmitted in the transmission system; and a calculating unit, for calculating the plurality of delay periods of the clock signal and the at least one data signal according to the at least one transmission time difference; and a plurality of clock delaying units, for delaying the clock signal and the at least one data signal according to the plurality of delay periods, to synchronize the clock signal and the at least one data signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a high speed serial transmission interface of the prior art.

FIG. 2A illustrates a sequence diagram of a clock signal and a data signal in the transmission system shown in FIG. 1.

FIG. 2B illustrates a signal sequence diagram of the data signal shown in FIG. 2A leading over the clock signal.

FIG. 2C illustrates a signal sequence diagram of the data signal shown in FIG. 2A lagging behind the clock signal.

FIG. 3 illustrates a schematic diagram of another transmission interface and its related signals of the prior art.

FIG. 4A illustrates a schematic diagram of a transmission system according to an embodiment of the present invention.

FIG. 4B illustrates a schematic diagram of a calibration circuit in a transmission system shown in FIG. 4A.

FIG. 5 and FIG. 6 illustrate a sequence diagram of a detecting unit lagging a data signal and a clock signal in a calibration circuit shown in FIG. 4B.

FIG. 7 illustrates a sequence diagram of a signal transmission interval versus its corresponding lagging period in a transmission system shown in FIG. 4A.

FIG. 8 illustrates a schematic diagram of a different embodiment of the transmission system shown in FIG. 4A.

FIG. 9 illustrates a schematic diagram of a different embodiment and its related differential signals of the transmission system shown in FIG. 4A.

FIG. 10 illustrates a schematic diagram of a signal calibration process according to an embodiment of the present invention.

FIG. 11A and FIG. 11B illustrate a waveform to represent indicating tasks of a host circuit in the transmission system shown in FIG. 4A.

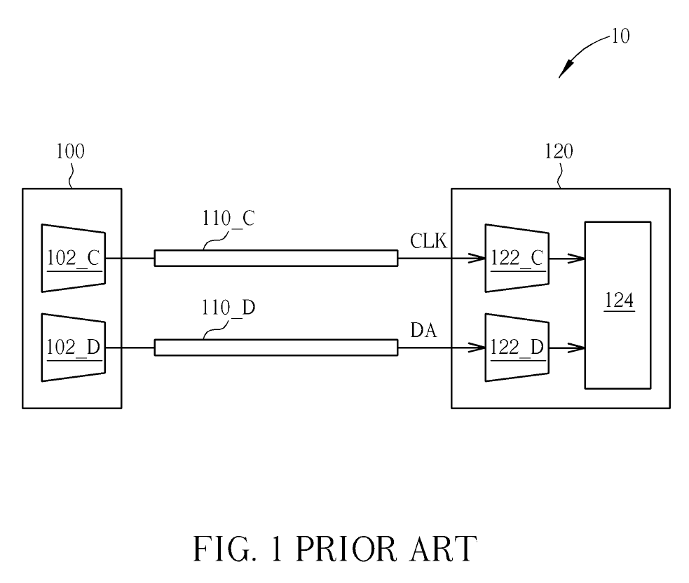

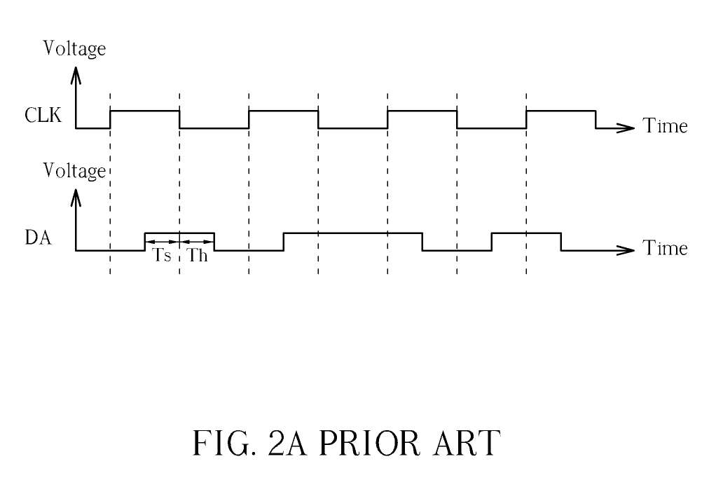

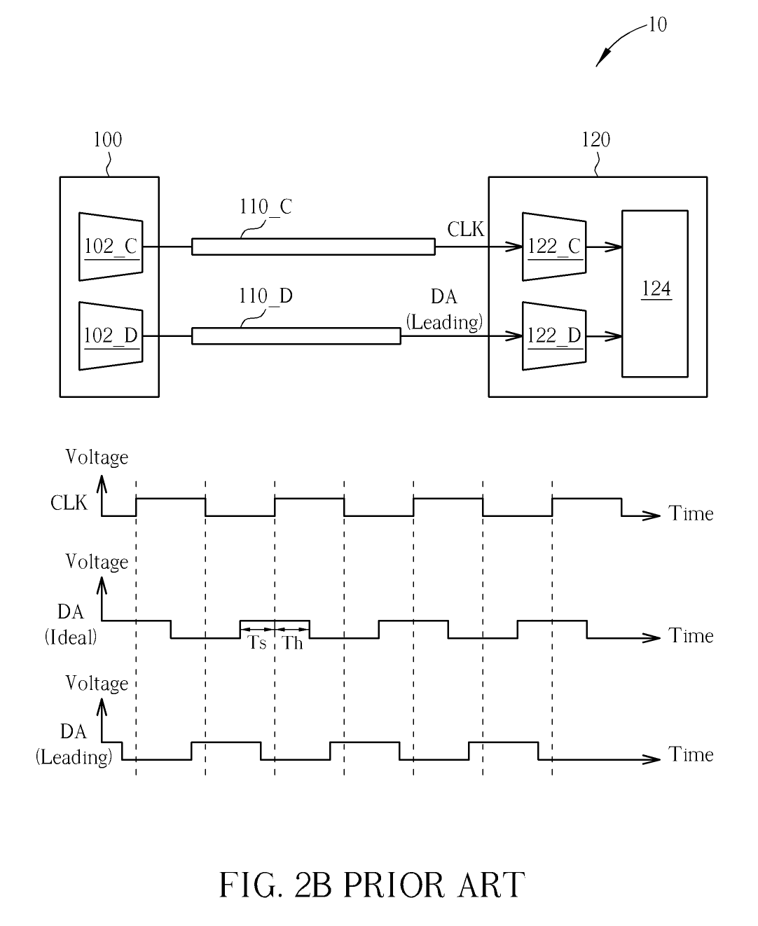

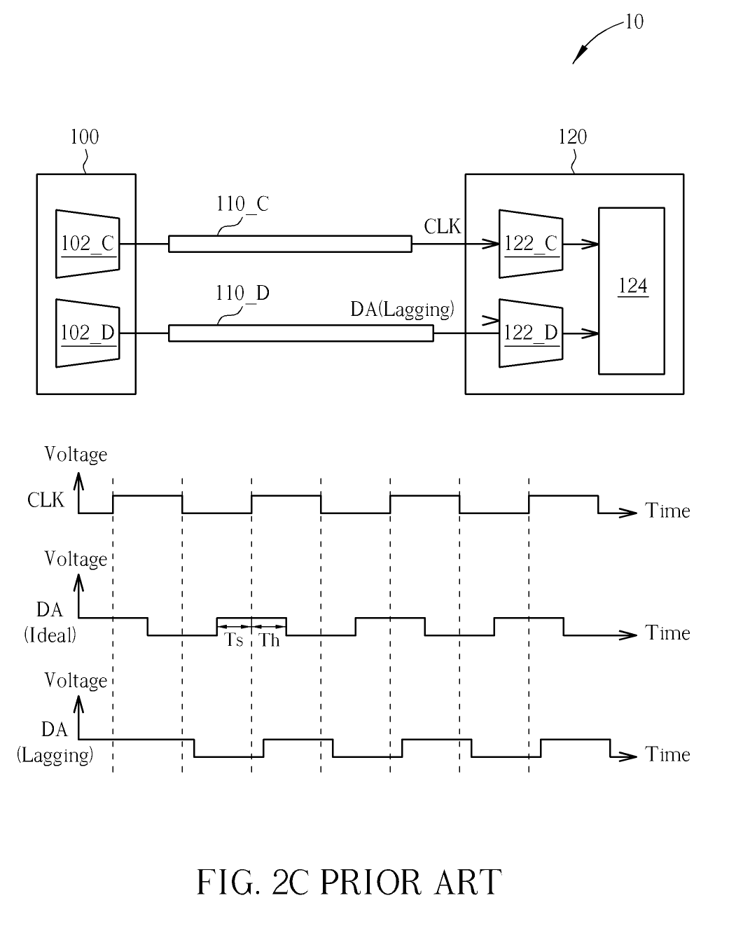

### DETAILED DESCRIPTION

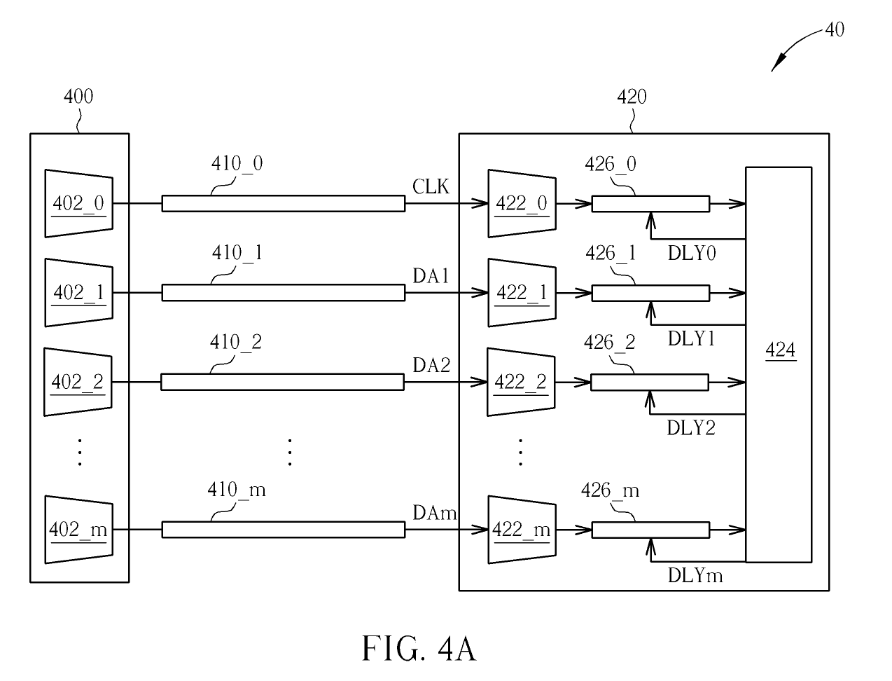

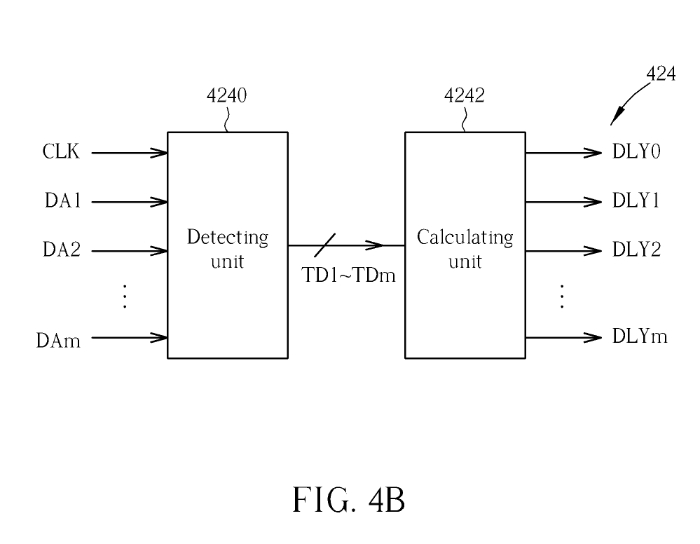

Please refer to FIG. 4A, which illustrates a schematic diagram of a transmission system 40 according to an embodiment of the present invention. The transmission system 40 transmits a clock signal CLK and data signals DA1-DAm. The transmission system 40 comprises a host circuit 400, transmission lines 410_0-410_{—}m and a client circuit 420. The host circuit comprises transmitters 402_0-402_{—}m, for transmitting the clock signal CLK and the data signals DA1-DAm, respectively. The client circuit 420 comprises receivers 422_0-422_{—}m, a calibration circuit 424 and delaying units 426_0-426_{—}m. The receivers 422_0-422_{—}m receive the clock signal CLK and the data signals DA1-DAm. The calibration circuit 424 comprises a detecting unit 4240 and a calculating unit 4242. As shown in FIG. 4B, the detecting unit 4240 detects transmission time differences TD1-TDm between the clock signal CLK and the data signals DA1-DAm in the transmission system 40. The calculating unit 4242 calculates delay periods DLY0-DLYm of the clock signal CLK and the data signals DA1-DAm according to the transmission time differences TD1-TDm. Finally, the delaying units 426_0-426_{—}m delay the clock signal CLK and the data signals DA1-DAm according to the delay periods DLY0-DLYm, respectively, to synchronize the clock signal CLK and the data signals DA1-DAm.

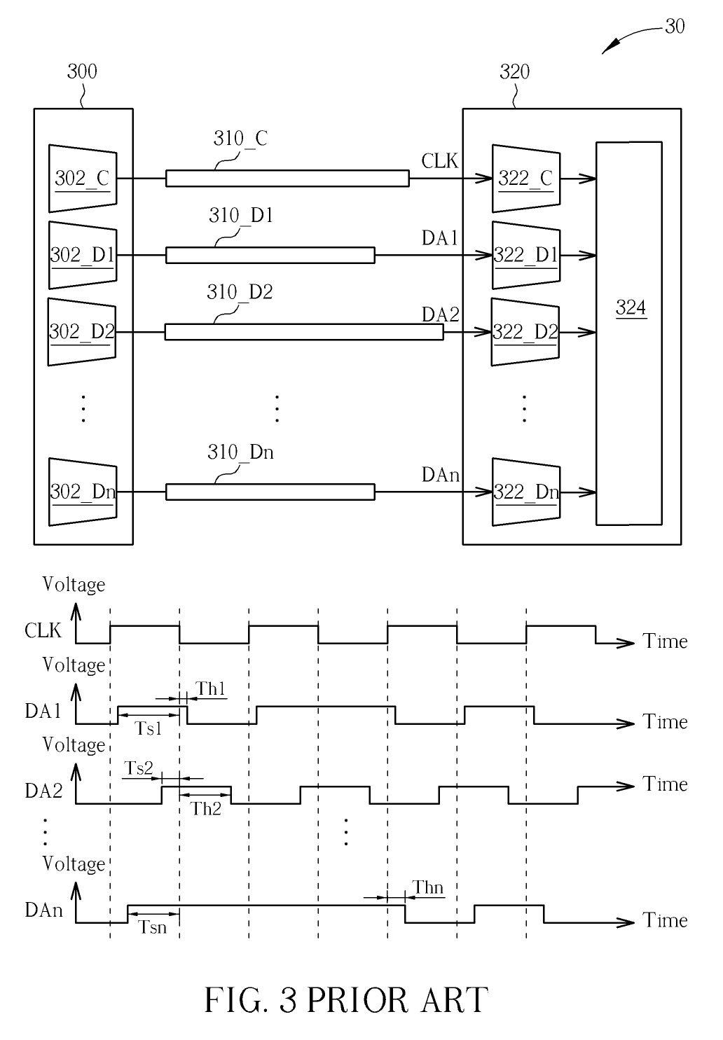

In short, since the client circuit 420 can not learn the amount of skew of those received signals, the client circuit 420 executes a calibration process before starting to access the data signals DA1-DAm. The calibration circuit 424 compares the transmission time differences TD1-TDm between the clock signal CLK and the data signals DA1-DAm, determining a slowest signal among all the transmitted signals, delaying other signals except for the slowest signal, transmitting a phase of the slowest signal to catch up with phases of the other signals, so as to synchronize all the signals. Comparing with the transmission interface 30 shown in FIG. 3, the signal calibration method of the transmission system 40 can be utilized by executing built-in commands without increasing overheads to the system.

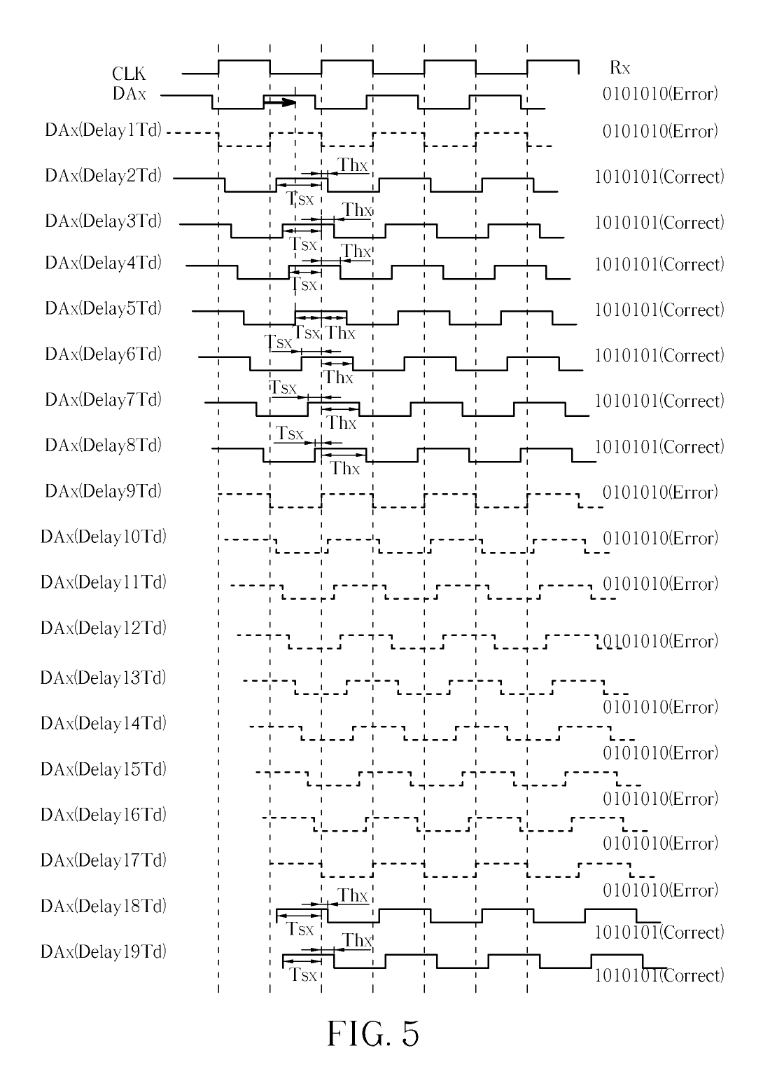

In detail, please refer to FIG. 5, which illustrate a schematic diagram of the detecting unit 4240 which detects the transmission time differences TD1-TDm. For the each data signal DAx, the detecting unit 4240 delays the data signal DAx with different multiples of a unit time Td, such as 1Td, 2Td, . . . , kTd. In FIG. 5 with k=19, the detecting unit 4240 accesses the delayed data signal DAx according to rising edges of the clock signal CLK and falling edges of the clock signal CLK, to generate a testing result Rx. As the result, the detecting unit 4240 compares the testing result with a correct transmission result corresponding to the data signal DAx, to determine the transmission time difference TDx. For example, as shown in the FIG. 5, the correct transmission result is “1010101”. When the data signal DAx is delayed for 2Td-8Td, 18Td and 19Td, the testing result complies with the correct transmission result. Since the delay period is 5Td, the shortest periods of the rising and falling edges of the clock signal CLK and the rising and falling edges of the data signal DAx are Tsx and Thx, respectively, and they are the most symmetric. The detecting unit 4240 can determine the data signal DAx leading over the clock signal CLK for 5Td, that is the transmission time difference is TDx=5Td. Similarly, by more data comparison, the detecting unit 4240 can acquire all the transmission time differences TD1-TDm between all the data signals DA1-DAm and the clock signal CLK as a basis of determining the slowest transmitted signal.

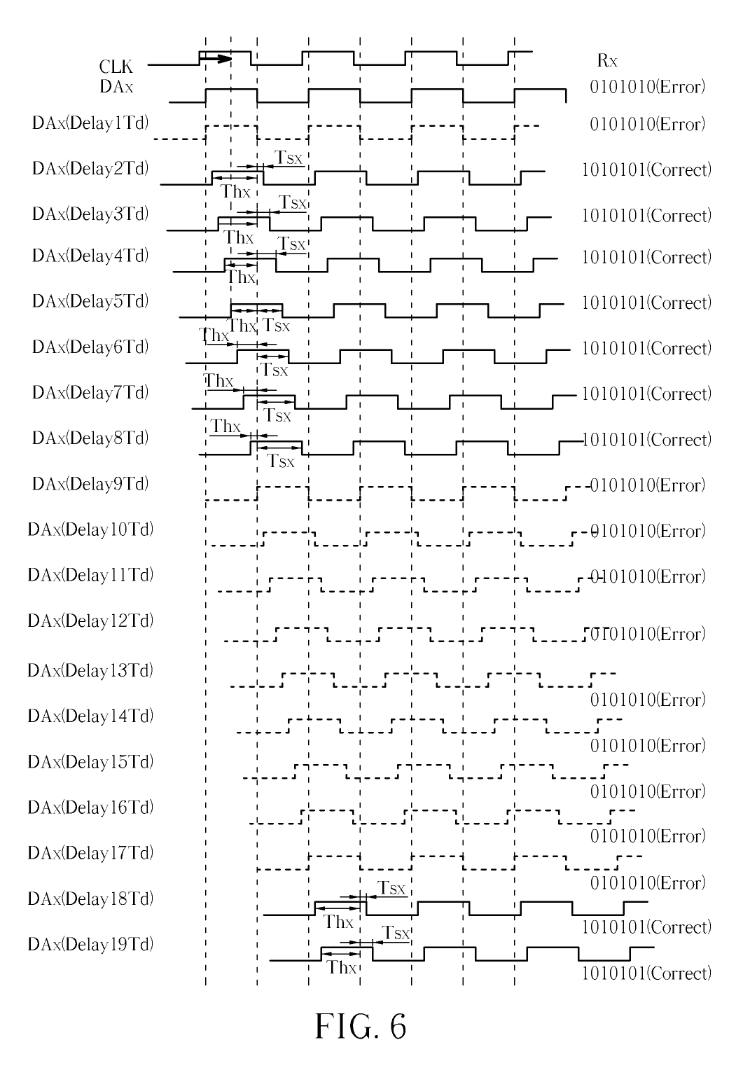

Certainly, the detecting unit 4240 not only delays the data signals DA1-DAm as well as the clock signal CLK with different multiples of a unit period Td, such as 1Td, 2Td, . . . , kTd, but also compares the transmission results to acquire the transmission time differences TD1-TDm. As shown in FIG. 6, in which the process is similar to the process in FIG. 5, and is not further described. As known from FIG. 5 and FIG. 6, smaller the unit period Td is, more accurate transmission time differences TD1-TDm are detected by the detecting unit 4240.

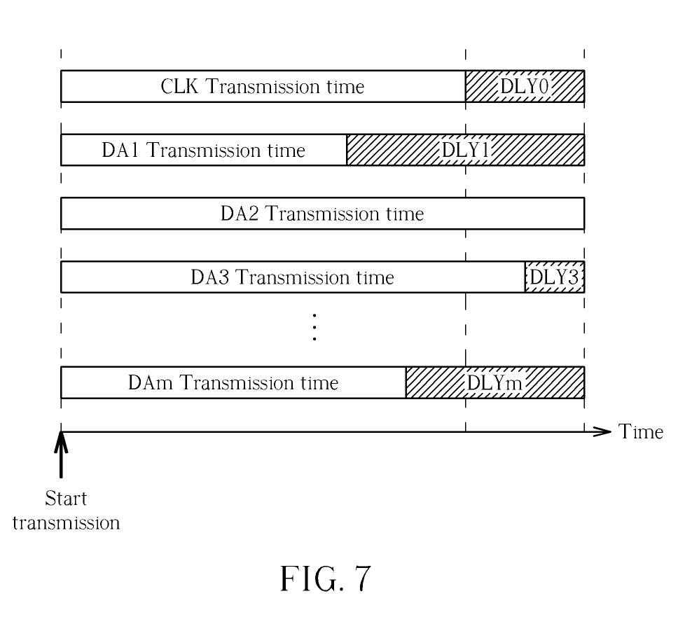

Once the transmission time differences TD1-TDm are known, the calculating unit 4242 can determine the slowest signal among the clock signal CLK and the data signals DA1-DAm according to the transmission time differences TD1-TDm, and a plurality of leading periods of the clock signal CLK and the data signals DA1-DAm relative to the slowest signal. As shown in FIG. 7, which illustrates the slowest signal as the data signal DA2, and the clock signal CLK and the data signals DA1-DAm lead over the slowest signal with DLY0-DLYm, respectively. In other words, the delaying units 426_0-426_{—}m use DLY0-DLYm as the delay periods to synchronize the clock signal CLK and the data signals DA1-DAm according to delaying the clock signal CLK and the data signals DA1-DAm, respectively.

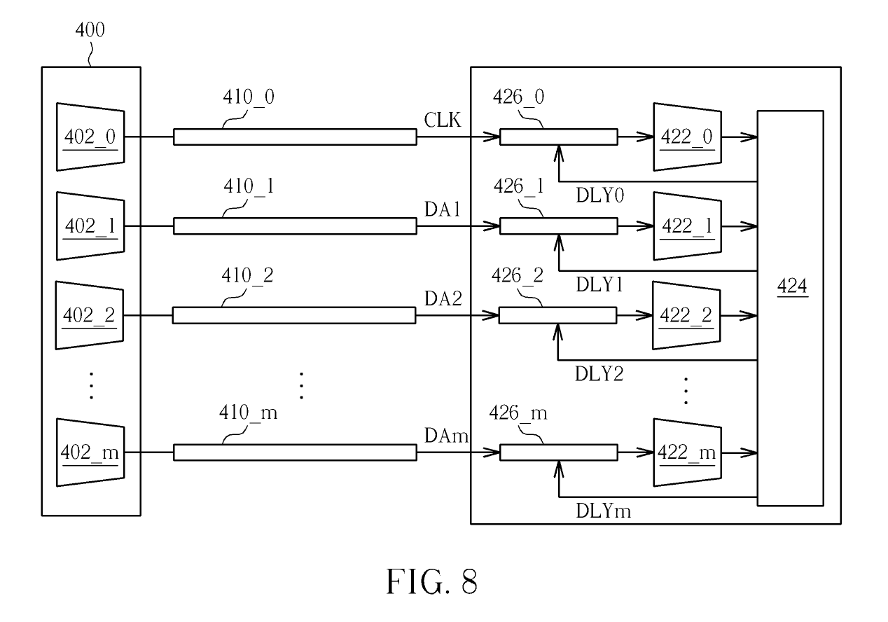

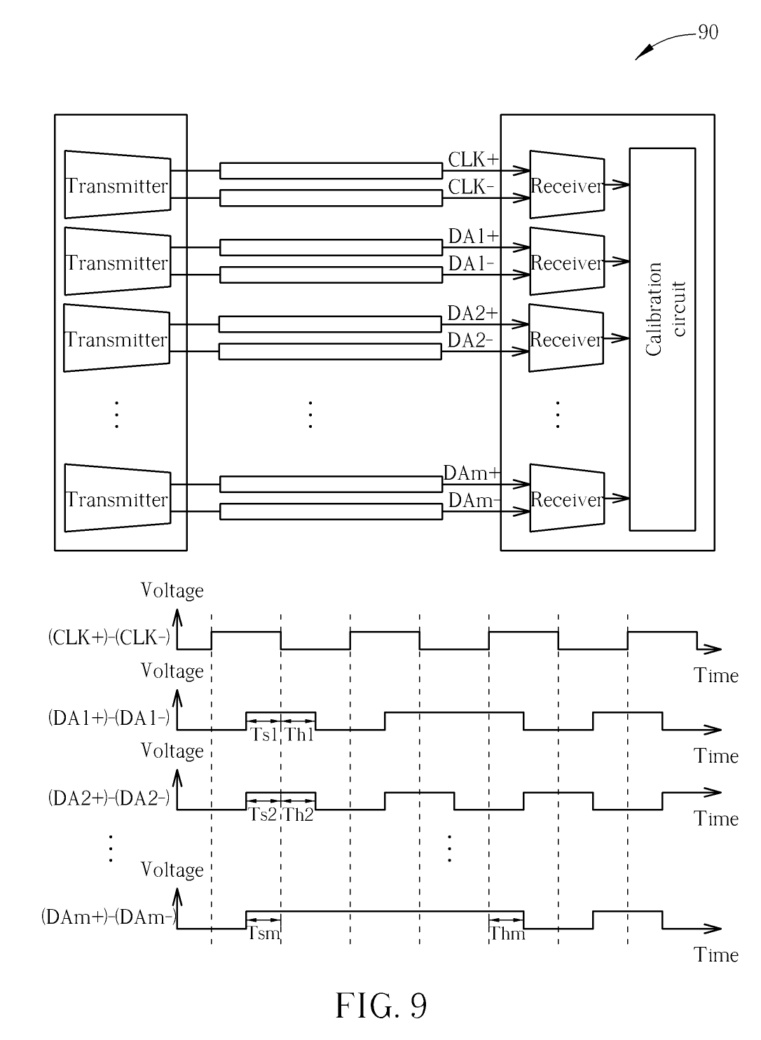

Noticeably, the delaying units 426_0-426_{—}m are disposed in between the receivers 422_0-422_{—}m and the calibration circuit 424, also, and disposed before the receivers 422_0-422_{—}m, as shown in FIG. 8. In addition, the present invention can also be applied to differential signal transmitted in a transmission system 90, as shown in FIG. 9, in which transmission lines transmitting the same differential pairs match and there exists no skew between positive differential signals and negative differential signals. Therefore, the signal calibration method disclosed in the present invention can directly apply to differential signals and is similar to related details of the transmission system 40, and is not further described.

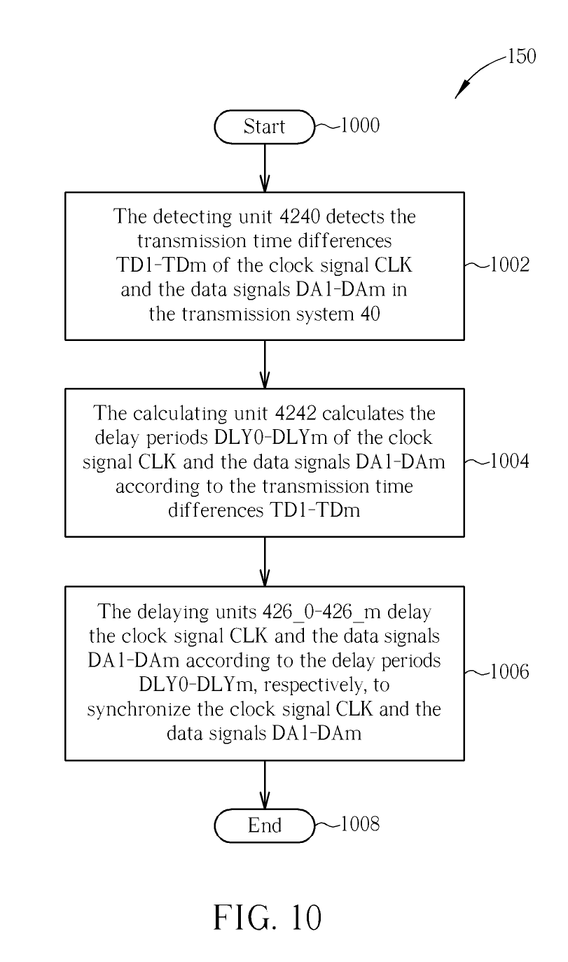

Operation of the transmission system 40 can be summarized into a signal calibration process 150 shown in FIG. 10. The signal calibration process 150 comprises following steps:

Step 1000: Start.

Step 1002: The detecting unit 4240 detects the transmission time differences TD1-TDm of the clock signal CLK and the data signals DA1-DAm in the transmission system 40.

Step 1004: The calculating unit 4242 calculates the delay periods DLY0-DLYm of the clock signal CLK and the data signals DA1-DAm according to the transmission time differences TD1-TDm.

Step 1006: The delaying units 426_0-426_{—}m delay the clock signal CLK and the data signals DA1-DAm according to the delay periods DLY0-DLYm, respectively, to synchronize the clock signal CLK and the data signals DA1-DAm.

Step 1008: End.

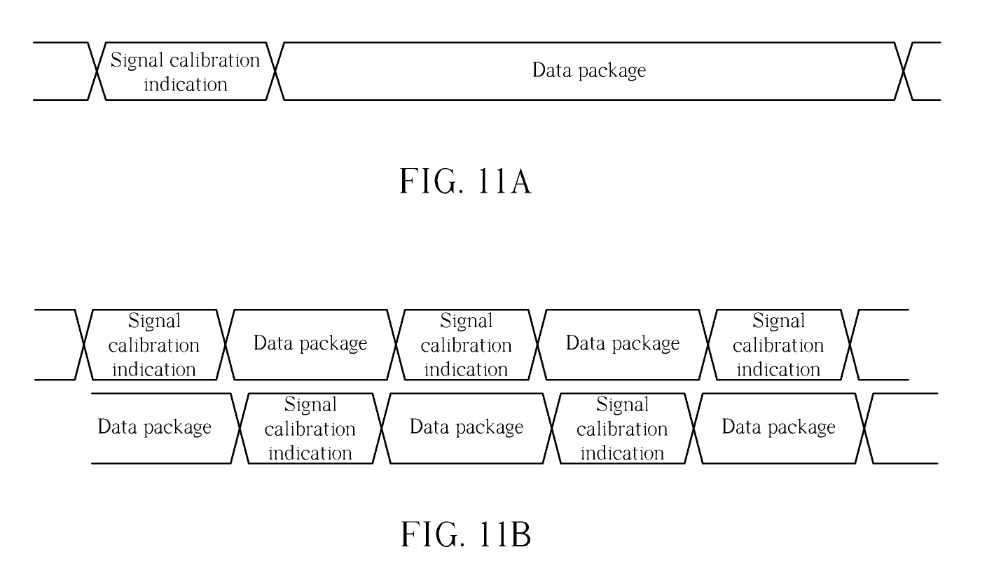

Details of the signal calibration process 150 can be seen from above, and is not further described. Theoretically, executing once the signal calibration process 150 can calibrate the skew of the transmitted signals caused by the transmission environment. Please refer to FIG. 11A, which illustrates a waveform to represent indicating tasks of the host circuit 400. The host circuit 400 can input indications of the signal calibration process 150 into the data signals DA1-DAm before the client circuit 420 officially accessing the data, to synchronize the signals and to make sure accuracy of receiving data shown in FIG. 11A. Certainly, considering for different application, it is feasible to periodically input and execute the signal calibration process 150 during a signal transmission process, to make a system more stable and to eliminate the randomly appearing skew factors, such as changes of temperature or changes of voltage, as shown in FIG. 11B.

In the prior art, non-ideal transmission factors, such as asymmetrical lengths or loadings of the transmission lines, asymmetrical loadings of receivers, asymmetrical outputs of the transmitters, cause the skew appearing in the transmitted signals, such that the client circuit 120 generates errors when accessing data. In comparison, the present invention compares the transmission result, estimating the transmission time differences TD1-TDm among different signals, lagging the “leading” signals accordingly, to synchronize all signals so as to make sure accuracy of accessing data. Furthermore, the signal calibration method of the transmission system 40 can be utilized by executing built-in commands without increasing overheads to the system.

To sum up, the present invention compares the transmission result, estimating the transmission time differences among different signals, lagging the “leading” signals accordingly, to synchronize all signals so as to make sure the accuracy of accessing data.

Those skilled in the art will readily observe that numerous modifications and alterations of the device and method may be made while retaining the teachings of the invention.

What is claimed is:

1. A signal calibration method for synchronizing a clock signal and at least one data signal in a transmission system, the signal calibration method comprising:
detecting at least one transmission time difference between the clock signal and the at least one data signal transmitted in the transmission system;
calculating a plurality of delay periods of the clock signal and the at least one data signal according to the at least one transmission time difference; and
delaying the clock signal and the at least one data signal for the plurality of delay periods, respectively, to synchronize the clock signal and the at least one data signal.

2. The signal calibration method of claim 1, wherein the step of detecting the at least one transmission time difference between the clock signal and the at least one data signal transmitted in the transmission system further comprises:
delaying different multiples of a unit period for each of the at least one data signal, to generate a plurality of testing results according to the clock signal; and
comparing the plurality of the testing results with a correct transmission result for the each data signal, to determine the at least one transmission time difference.

3. The signal calibration method of claim 1, wherein the step of detecting the at least one transmission time difference between the clock signal and the at least one data signal transmitted in the transmission system comprises:
delaying different multiples of a unit period for the clock signal, to generate a plurality of testing results according to the clock signal; and
comparing the plurality of testing results with a correct transmission result corresponding to each data signal, to determine the at least one transmission time difference.

4. The signal calibration method of claim 1, wherein the step of calculating the plurality of delay periods of the clock signal and the at least one data signal according to the at least one transmission time difference comprises:
determining a slowest signal among the clock signal and the at least one data signal according to the at least one transmission time difference; and
calculating a plurality of leading periods of the clock signal and the at least one data signal relative to the slowest signal as the plurality of delay periods.

5. The signal calibration method of claim 1, wherein the clock signal and the at least one data signal are differential signals.

6. A client circuit for receiving and synchronizing a clock signal and at least one data signal transmitted in a transmission system, the client circuit comprising:
a plurality of receivers, for receiving the clock signal and the at least one data signal;
a calibration circuit, comprising:
a detecting unit, for detecting at least one transmission time difference between the clock signal and the at least one data signal transmitted in the transmission system; and
a calculating unit, for calculating a plurality of delay periods of the clock signal and the at least one data signal according to the at least one transmission time difference; and
a plurality of clock delaying units, for delaying the clock signal and the at least one data signal according to the plurality of delay periods, to synchronize the clock signal and the at least one data signal.

7. The client circuit of claim 6, wherein the detecting unit is utilized for:
delaying different multiples of a unit period for each of the at least one data signal, to generate a plurality of testing results according to the clock signal; and
comparing the plurality of the testing results and a correct transmission result of the each data signal, to determine the at least one transmission time difference.

8. The client circuit of claim 6, wherein the detecting unit is utilized for:
delaying different multiples of a unit period for the clock signal, to generate a plurality of testing results according to the at least one data signal; and
comparing the plurality of testing results with a correct transmission result corresponding to each data signal, to determine the at least one transmission time difference.

9. The client circuit of claim 6, wherein the calculating unit is utilized for:
determining a slowest signal among the clock signal and the at least one data signal according to the at least one transmission time difference; and
calculating a plurality of leading periods of the clock signal and the at least one data signal relative to the slowest signal as the plurality of delaying periods.

10. The client circuit of claim 6, wherein the clock signal and the at least one data signal are differential signals.

11. A transmission system for transmitting a clock signal and at least one data signal, the transmission system comprising:
a host circuit comprising:
a plurality of transmitters, for transmitting the clock signal and the at least one data signal;
a plurality of transmission lines, for transmitting the clock signal and the at least one data signal, respectively;
a client circuit comprising:
a plurality of receivers, for receiving the clock signal and the at least one data signal;
a calibration circuit, comprising:
a detecting unit, for detecting at least one transmission time difference between the clock signal and the at least one data signal transmitted in the transmission system; and
a calculating unit, for calculating the plurality of delay periods of the clock signal and the at least one data signal according to the at least one transmission time difference; and
a plurality of clock delaying units, for delaying the clock signal and the at least one data signal according to the plurality of delay periods, to synchronize the clock signal and the at least one data signal.

12. The transmission system of claim 11, wherein the detecting unit is utilized for:
delaying different multiples of a unit period for each of at least the data signal, to generate a plurality of testing results according to the clock signal; and
comparing the plurality of testing results and a correct transmission result for the each data signal, to determine the at least one transmission time difference.

13. The transmission system of claim 11, wherein the detecting unit is utilized for:
delaying different multiples of a unit period for the clock signal, to generate a plurality of testing results according to the clock signal; and
comparing the plurality of testing results with a correct transmission result corresponding to each data signal, to determine the at least one transmission time difference.

14. The transmission system of claim 11, wherein the calculating unit is utilized for:
determining a slowest signal among the clock signal and the at least one data signal according to the at least one transmission time difference; and
calculating a plurality of leading periods of the clock signal and the at least one data signal relative to the slowest signal as the plurality of delay periods.

15. The transmission system of claim 11, wherein the clock signal and the at least one data signal are differential signals.
